(19) United States
(12) Patent Application Publication
(10) Pub. No.: US 2026/0067920 A1
(43) Pub. Date: Mar. 5, 2026

(54) SCALABLE TRAFFIC ARBITRATION FOR MULTIPLE RADIOS

(71) Applicant: Silicon Laboratories Inc., Austin, TX (US)

(72) Inventors: Aditya Sarda, Leander, TX (US); Logan Lucas, Austin, TX (US)

(21) Appl. No.: 18/822,782

(22) Filed: Sep. 3, 2024

(51) Int. Cl. H04W 72/56; H04W 76/18

(52) U.S. Cl. CPC H04W 72/56; H04W 76/18

(57) ABSTRACT

An arbitration circuit receives a plurality of radio requests from a plurality of radios. The arbitration circuit includes sorting circuit to rank the radio requests according to priority, grant circuit to generate a grant signal to a highest priority radio request of the plurality of radio requests. The grant circuit is further configured to generate a grant or deny to each remaining lower priority radio request of the plurality of radio requests according to a concurrency relationship between each of the remaining lower priority radio requests and each higher priority radio request that has a grant. Transmit and receive request buses driven by the radios supply the arbitration circuit with requests that indicate request priority. Grant masking masks grants to a radio request until all radios are off that have a transmit or receive request that is non-concurrent with the request being granted.

### BACKGROUND

### Field of the Invention

This disclosure relates to radios and more particularly to arbitration between multiple radios.

### Description of the Related Art

Many Internet of Things (IOT) devices incorporate multiple radio frequency (RF) sections and digital radios within the same integrated circuit die. RF section refers to the analog chain of the RF path and digital radio refers to digital modem(s) used with the RF section to form radios in the IOT device. For some devices external transceiver chips can also be present in the overall solution along with the multiple RF sections and digital radios. In addition, some of the RF sections can support multiple communication protocols. It is desirable to efficiently manage and switch between the different protocols and radios to help ensure good system performance. That requires arbitration between the various protocols and radios.

One concept involved in arbitration between protocols is a software-based implementation known as Dynamic Multi Protocol (DMP). In a similar fashion, a firmware based approach in some current devices controls a shared radio and/or radios between Wi-Fi, Bluetooth Low Energy (BLE), and Bluetooth Classic. In other devices, DMP shares the radio(s) between some combination of BLE, ZigBee, and other protocols. While the mechanisms are slightly different, the implementations involve a scheduler to allocate the shared radio resources in an appropriate manner to multiple requestors. For example, in one implementation, one radio, e.g., the Wi-Fi radio has priority and Bluetooth radios request permission from the Wi-Fi radio to transmit and receive. For the rest of this document the software/firmware approach will be referred to as the software scheduler. Note that when multiple radios are present in the system, there can be more than one active protocol running. The software scheduler allows this and schedules radio resources accordingly. However, the software scheduler may not always allocate radio resources in a timely manner.

Accordingly, improvements in arbitration between multiple radio protocols would be desirable.

### SUMMARY OF EMBODIMENTS OF THE INVENTION

In an embodiment a method for arbitrating radio requests from a plurality of radios includes receiving a plurality of radio requests from the plurality of radios at an arbitration circuit. The arbitration circuit sorts the radio requests to rank the requests according to priority. The arbitration circuit grants a highest priority radio request and either grants or denies each remaining lower priority radio request of the plurality of radio requests according to respective concurrency relationships between each remaining lower priority radio request with every higher priority radio request that has a grant.

In another embodiment an apparatus includes a plurality of radios. An arbitration circuit is coupled to receive a plurality of radio requests from the plurality of radios. The arbitration circuit includes sorting circuit to rank the radio requests according to priority and grant circuit to generate a grant signal to a highest priority radio request of the plurality of radio requests. The grant circuit is further configured to generate a grant or deny to each remaining lower priority radio request of the plurality of radio requests according to a concurrency relationship between each of the remaining lower priority radio requests and each higher priority radio request that has a grant.

In another embodiment an apparatus includes a plurality of radios including a first radio and a second radio. An arbitration circuit is coupled to receive radio requests from the plurality of radios. The arbitration circuit includes sorting circuit to rank the radio requests according to priority and grant circuit to generate a grant signal to a highest priority radio request. The grant circuit is further configured to generate a grant or deny to each remaining lower priority radio request of the radio requests according to a concurrency relationship between each of the remaining lower priority radio requests and each higher priority radio request that has a grant generated by the grant circuit. A first transmit request bus is coupled between the first radio and the arbitration circuit. A first receive request bus is coupled between the first radio and the arbitration circuit. A second transmit request bus is coupled between the second radio and the arbitration circuit. A second receive request bus is coupled between the second radio and the arbitration circuit. A first transmit grant signal line is coupled between the arbitration circuit and the first radio, and the first transmit grant signal line is asserted to indicate a first transmit request on the first transmit request bus is being granted. A first receive grant signal line is coupled between the arbitration circuit and the first radio, and the first receive grant signal line is asserted to indicate a first receive request on the first receive request bus is being granted. A second transmit grant signal line is coupled between the arbitration circuit and the second radio, and the second transmit grant signal line is asserted to indicate a second transmit request on the second transmit request bus is being granted. A second receive grant signal line is coupled between the arbitration circuit and the second radio, and the second receive grant signal line is asserted to indicate a second receive request on the second receive request bus is being granted. A first transmit deny signal line is coupled between the arbitration circuit and the first radio, and the first transmit deny signal line is asserted to deny a third transmit request on the first transmit request bus. A first receive deny signal line is coupled between the arbitration circuit and the first radio, and the first receive deny signal line is asserted to deny a third receive request on the first receive request bus. A second transmit deny signal line is coupled between the arbitration circuit and the second radio, and the second transmit deny signal line is asserted to deny a fourth transmit request on the second transmit request bus. A second receive deny signal line is coupled between the arbitration circuit and the second radio, and the second receive deny signal line is asserted to deny a fourth receive request on the second receive request bus.

### BRIEF DESCRIPTION OF THE DRAWINGS

The present invention may be better understood, and its numerous objects, features, and advantages made apparent to those skilled in the art by referencing the accompanying drawings.

FIG. 1 illustrates a high-level block diagram of an embodiment of a wireless communication system supporting real time arbitration.

FIG. 2 illustrates an embodiment of a transmitter.

FIG. 3 illustrates an embodiment of a receiver.

FIG. 4 illustrates an example of TX and RX arbitration configuration registers.

FIG. 5 is a flow diagram illustrating the operation of the PITA hardware block.

FIG. 6 illustrates a concurrency table used to decide whether to grant or deny lower priority radio requests.

FIG. 7 is a timing diagram illustrating masking the grant and a deny until all non-concurrent radios are off.

FIG. 8 illustrates a high level block diagram of the PITA hardware block.

FIG. 9 illustrates an embodiment of the sorter in the PITA hardware block.

The use of the same reference symbols in different drawings indicates similar or identical items.

### DETAILED DESCRIPTION

Another concept in arbitration between radio protocols besides DMP is packet arbitration. Packet arbitration is intended to prevent collisions between RF signals within a system when operating within the same frequency band. With multiple independent radios and RF paths in the system, multiple protocols can be operating simultaneously. That makes the software scheduler ineffective at times as decisions for transmission and reception need to be made in real time due to protocol requirements and the software scheduler cannot make such decisions fast enough.

Several use cases provide examples of the need for effective packet arbitration. A Wi-Fi station should not go off air without informing the Access Point (AP) of its unavailability. Unless explicitly informed by the Wi-Fi station, the AP assumes that the Wi-Fi Station is available for reception and may send a packet asynchronously. If the station is actually unavailable, multiple retries will occur causing congestion in the network and a drop in the Wi-Fi rate/throughput. To announce its unavailability to the AP for an extended duration (e.g., 10s/100s of milliseconds), the Wi-Fi Station sets the power management (PM) bit in a packet sent to the AP. Under heavy traffic conditions, it may take several milliseconds for the packet with the PM bit set to be transmitted to AP. Such heavy traffic conditions include, e.g., congestion or heavy receive traffic with aggregated MAC protocol data units (AMPDUs). Thus, the Wi-Fi station may need several milliseconds to go off-air (gracefully) in heavy traffic conditions. Effective arbitration plays an important role in such circumstances to avoid unnecessary congestion and reduced throughput.

While in a power save mode, a Wi-Fi station periodically wakes up and listens for a beacon. APs transmit beacons at regular intervals. The beacon includes a traffic indication map (TIM) in the beacon frame. A station in low power mode periodically wakes up and listens to the beacon. The TIM contains a bitmap representing each associated station. If the station's bit is set to “1”, that indicates the AP has data waiting for that station and the station sends a frame indicating it is ready to receive data and then the AP sends the data to the station. The software scheduler schedules the periodic wakeup and a packet arbitration request can be used to allow the station to send the response and retrieve the data. That requires a quick turn around from receive (RX) to transmit (TX) that would be facilitated by packet arbitration.

Another use case for packet arbitration involves low power wireless (LPW) protocols such as BLE and Zigbee which require switching from receive to transmit mode at short notice. There is always a possibility that Wi-Fi and one of the LPW protocols is in continuous receive mode and suddenly makes a transition to transmit mode. Most radios on integrated circuits do not support simultaneous transmissions in the 2.4 GHz frequency spectrum and most likely do not support simultaneous 2.4 GHz transmission on one antenna and receive on another antenna. It is problematic to invoke the software scheduler in these circumstances to make the necessary arbitration decision and block one of the radios transmission or reception in a timely manner. However, packet arbitration can be used to handle such scenarios.

Bluetooth voice profiles follow highly synchronized transmit and receive patterns. Bluetooth voice profiles are standardized protocols that enable various types of voice communication over Bluetooth devices. The radio activity usually lasts for a short duration (e.g., 1.25-2.5 milliseconds (ms) but at very high periodicity (3.75, 7.5 or 10 ms). That presents a challenge for the software scheduler with respect to scheduling the Wi-Fi radio. As Bluetooth voice profiles typically leave just 5-7 ms of radio time for other protocols, overhead incurred by the software scheduler could be problematic in terms of consuming valuable time. Some examples of Bluetooth voice profiles include Headset Profile (HSP), Hands-Free Profile (HFP), Advanced Audio Distribution Profile (A2DP), and Audio/Video Remote Control Profile (AVRCP). HSP is used for basic audio communication, such as for Bluetooth headsets. HSP typically supports mono audio and basic call control features like answering and ending calls. HFP is similar to HSP but with more advanced features. HFP supports stereo audio and offers a wider range of call control functions, including voice dialing, call waiting, and call status updates. HFP is commonly used in car hands-free systems. While A2DP is not specifically a voice profile, A2DP allows for high-quality stereo audio streaming from a source device to a sink device, such as streaming music from a phone to Bluetooth headphones. AVRCP allows for remote control of audio and video devices, such as play, pause, and skip functions. It works alongside A2DP to control media playback. Bluetooth Low Energy (BLE) Voice Profiles for voice communication are used in low-power devices. While BLE is primarily designed for low-energy data exchange, it can support voice communication in some specialized use cases. Packet arbitration can be used for the various Bluetooth voice profiles to hold off the Wi-Fi radio and conserve radio time.

There are scenarios where LPW and the Wi-Fi network processor (NWP) cannot communicate a radio switch gracefully. For scenarios like real time voice exchange (Bluetooth needs the radio for 2.5 ms in every 7.5 ms) or simultaneous receive, it is not possible to run initialize-deinitialize procedures on individual modems and communicate between modems. For these kinds of scenarios, the expectation is that the two modems are working independently (as if the other modem does not exist at all) and that the packet arbitrator will block one of the protocols. The blocked protocol simply assumes that activity could not be completed for reasons like packet drop due to congestion over the air.

In order to implement packet arbitration to deal with the challenges outlined above and other limitations of software based arbitration, embodiments utilize a hardware packet arbitration block referred to herein as a Packetized Information Traffic Arbitrator (PITA) to facilitate real time packet arbitration. For the scenarios where the software scheduler cannot choose a particular protocol in time, the hardware based PITA allows multiple protocols to run more efficiently.

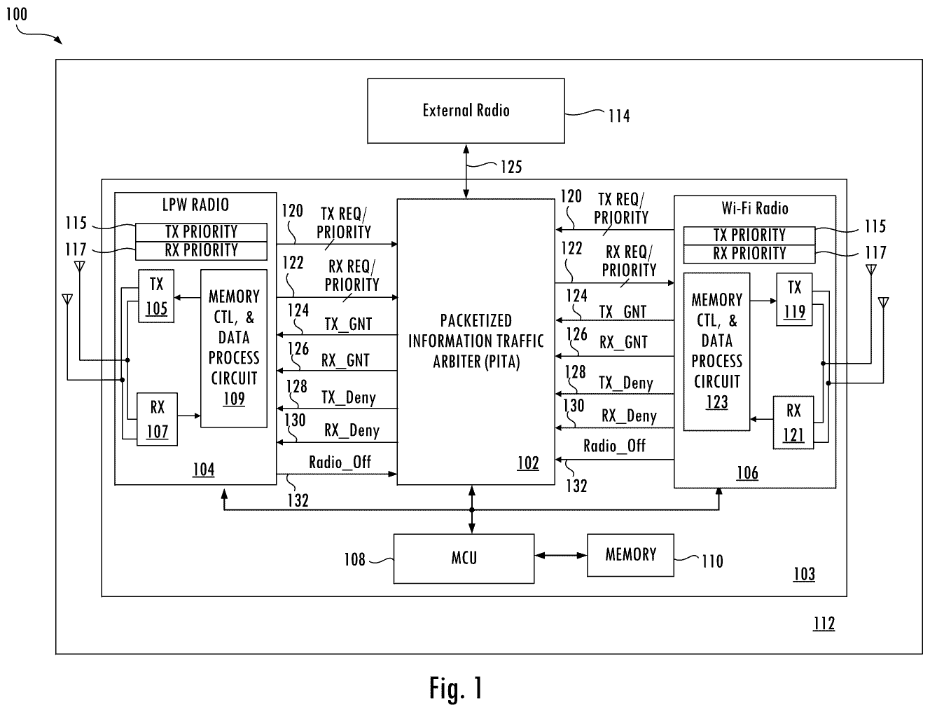

FIG. 1 illustrates a high-level block diagram of an embodiment of a wireless communication system 100 showing the PITA hardware block 102 on integrated circuit 103. The integrated circuit includes LPW radio 104 and Wi-Fi radio 106. Radio 104 includes transmitter 105, receiver 107, memory, control, and data processing circuitry 109. Wi-Fi radio 106 includes transmitter 119, receiver 121, memory, control, and data processing circuitry 123. The radios 104 and 106 may include multiple transmitters, multiple receivers, additional antennas, or a single antenna and additional RF components. Radio 104 communicates using one or more LPW protocols. Wi-Fi radio 106 communicates using Wi-Fi protocols.

A processor 108, e.g., a microcontroller unit (MCU) or other processor, runs the software scheduler stored in memory 110 and may provide other control functionality associated with the radios 104 and 106. While shown as a single block, the memory 110 typically includes volatile memory such as SRAM and/or DRAM as well as non-volatile memory. In addition, the memory may take the form of registers or storage within MCU 108 or elsewhere in system 100, such as in or accessible to radios 104 and 106. In addition, the printed circuit board (PCB) 112 on which the integrated circuit 103 is disposed includes an external radio (ER) 114 that is external to integrated circuit 103.

The radios supply their prioritized transmit and receive requests to PITA hardware block 102. PITA hardware block 102 compares the priorities for the various transmit and receive requests in a timely manner (typically faster than software arbitration) and allows the protocol with the highest priority to proceed with the requested operation. PITA hardware block 102 helps facilitate real time packet arbitration thereby helping resolve the challenges using a software scheduler presented in the various scenarios described above. For the scenarios where the software scheduler cannot choose a particular protocol in a timely manner, hardware-based packet arbitration allows multiple protocols to run more efficiently thereby utilizing radio resources more effectively. PITA hardware block provides for fast arbitration between the RF radios in the system to “share the air.” PITA hardware block 102 does not replace the software scheduler, e.g., DMP, but rather makes real time decisions on the priority of the next transmit or receive operation. Thus, e.g., the DMP may still schedule wakeups for the Wi-Fi radio. In addition to facilitating real time arbitration decisions, the PITA hardware block is scalable for a different number of requesting radios.

PITA hardware block 102 receives TX and RX requests 120 and 122 from each internal radio 104 and 106 in the form of an 8-bit bus from each radio. The interface 125 between PITA hardware block 102 and the external radio 114 will be described separately as that interface can vary in different embodiments. In at least one embodiment, the interface with the external radio is identical to the interfaces with the internal radios. The system provides the ability to program priority of RX and TX operations individually for each radio via their respective priority registers 115 and 117, which in an embodiment are a byte wide and accessible over the advanced peripheral bus (APB) or another bus. Since there are separate TX and RX priorities, each radio has two priority registers 115 and 117, one for TX and one for RX. Of course, in other embodiments the radios may have a wider priority register, e.g., 16 bits, or a narrower priority register, e.g., a 4 bit width. In an embodiment with a byte wide priority register the value of 255 indicates no request. Any other value on the priority bus indicates a request with that priority. Thus, in an embodiment priority is inversely related to the value on the request/priority bus and thus a lower number, e.g., 100, has a higher priority than a larger number, e.g., 200. Each radio provides their current transmit priority on their TX REQ/Priority bus 120 and their receive priority on their REQ/Priority bus 122. The Request/Priority bus 120 is a multi-bit bus with a continuous “level” signal. The signal levels on each TX and RX request bus can dynamically change during a transmission or reception. Thus, e.g., a start of a transmission, e.g., header information, can have a higher priority than another part of a transmission, e.g., a transmission with multiple data packets. Priority levels are software definable for flexibility.

PITA hardware block 102 receives the various priorities from the radios and grants or denies requests as described further herein. RX and TX operations are treated as independent radios from the point of view of PITA hardware block 102. Thus, RX and TX requests from a radio are granted separately based on their respective priority.

PITA hardware block 102 determines which radio has priority using an arbitration matrix. All the radios each have concurrency versus non concurrency relationships between them. If two radios are concurrent, they can be allowed to operate in parallel. If they are non-concurrent only the radio with the higher priority request should be allowed to operate. Depending on different modem to RF configurations, co-location of RF frequencies and other information, the software scheduler can program which radios are allowed to be concurrent versus non concurrent. PITA hardware block 102 supplies grant signals (TX_GNT and RX_GNT) 124 and 126 to each radio, which are asserted to indicate that a request has been granted. PITA hardware block 102 also supplies Deny signals (TX_Deny and RX_Deny) 128 and 130 to each radio, which are asserted to indicate that a request has been denied.

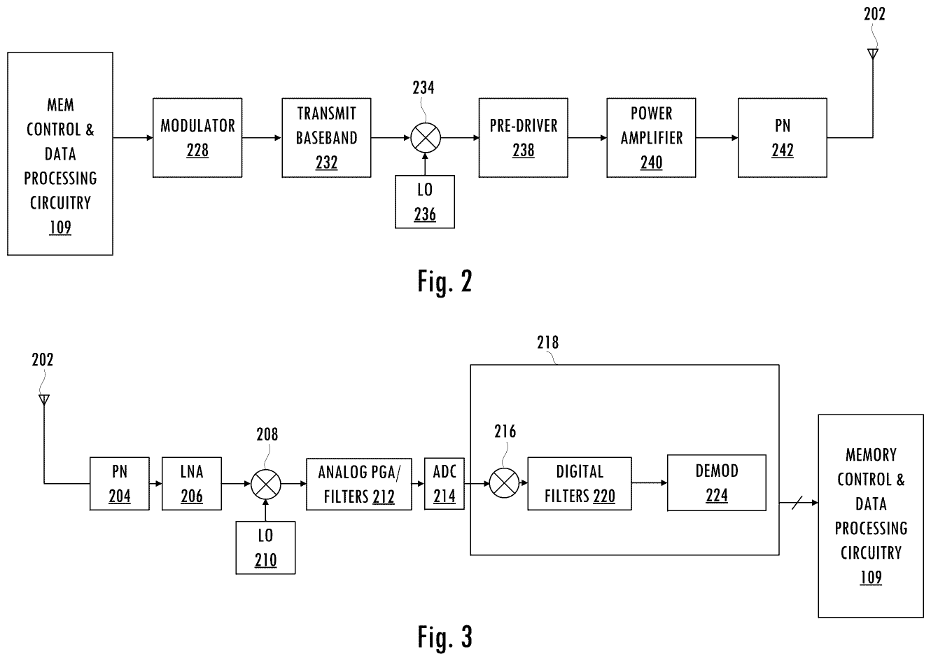

FIGS. 2 and 3 illustrate exemplary embodiments of the transmitter and receiver that may be present in at least one of the radios shown in FIG. 1, e.g., in LPW radio 104. The specific radio implementations depend on the RF protocols supported and the needs of a particular system. FIG. 2 illustrates an exemplary embodiment of transmitter 105 and/or 119 included in radios 104 and/or 106 of FIG. 1. Control and data processing circuitry and memory 109 and/or 123 perform a variety of functions (e.g., logic, arithmetic, etc.). For example, data processing circuitry 109 executes a program, routine, or algorithm (whether in software, firmware, hardware, or a combination thereof) that performs desired control or data processing tasks consistent with a physical layer of a communications protocol and provides data to modulator 228. Modulator 228 applies a predetermined modulation scheme (e.g., phase-shift keying or quadrature amplitude modulation, orthogonal frequency division multiplexing (OFDM)), to data for transmission and provides modulated data to transmit baseband circuit 232, which in an embodiment includes a digital-to-analog converter and analog programmable gain filters. Transmit baseband circuit 232 provides the baseband (or intermediate frequency (IF)) signal to frequency mixer 234, which performs frequency translation or shifting of the baseband signal using a reference or local oscillator (LO) signal provided by local oscillator 236. In at least one operational mode of transmitter 105, frequency mixer 234 translates the baseband signal centered at DC to a 2.4 GHz frequency band. Pre-driver 238 amplifies the signal generated by frequency mixer 234 to a level sufficient for power amplifier 240. Power amplifier 240 further amplifies the signal to provide a higher power signal sufficient to drive passive network 242 and antenna 202. Passive network 242 provides impedance matching, filtering, and electrostatic discharge protection.

FIG. 3 illustrates an exemplary embodiment of receiver 107 and/or 121 that may be included in a radio of the wireless communications devices described above. Antenna 202 provides a radio frequency (RF) signal to passive network 204, which provides impedance matching, filtering, and electrostatic discharge protection. Passive network 204 is coupled to low-noise amplifier 206, which amplifies the RF signal without substantial degradation to the signal-to-noise ratio and provides the amplified RF signal to frequency mixer 208. Frequency mixer 208 performs frequency translation or shifting of the RF signal using a reference or local oscillator signal provided by local oscillator 210. For example, in at least one operational mode of receiver 107, frequency mixer 208 translates the RF signal from a 2.4 GHz frequency band to baseband frequencies centered at DC (i.e., zero-intermediate frequency (ZIF) in a ZIF mode of operation). In another operational mode, receiver 107 and/or 123 is configured as a low-intermediate frequency (LIF) receiver (i.e., in a LIF mode of operation) and frequency mixer 208 translates the RF signal to a low-intermediate frequency (e.g., 100-200 kHz) to reduce or eliminate DC offset and 1/f noise problems of ZIF receivers.

Frequency mixer 208 provides the translated output signal as a set of two signals, an in-phase (I) signal and a quadrature (Q) signal. The I and Q signals are analog time-domain signals. In at least one embodiment of receiver 107, the analog programmable gain amplifier and filters 212 provide amplified and filtered versions of the I and Q signals to analog-to-digital converter (ADC) 214, which converts those versions of the I and Q signals to digital I and Q signals (i.e., I and Q samples). ADC 214 provides the digital I and Q signals to signal processing circuitry 218. In general, signal processing circuitry 218 performs digital signal processing (e.g., frequency translation (e.g., using digital mixer 216), filtering (e.g., using digital filters 220), demodulation, or signal correction) of the digital I and Q signals. In at least one embodiment, signal processing circuitry 218 includes demodulator 224, which recovers or extracts information from digital I and Q signals that were received as modulated RF signals by antenna 202.

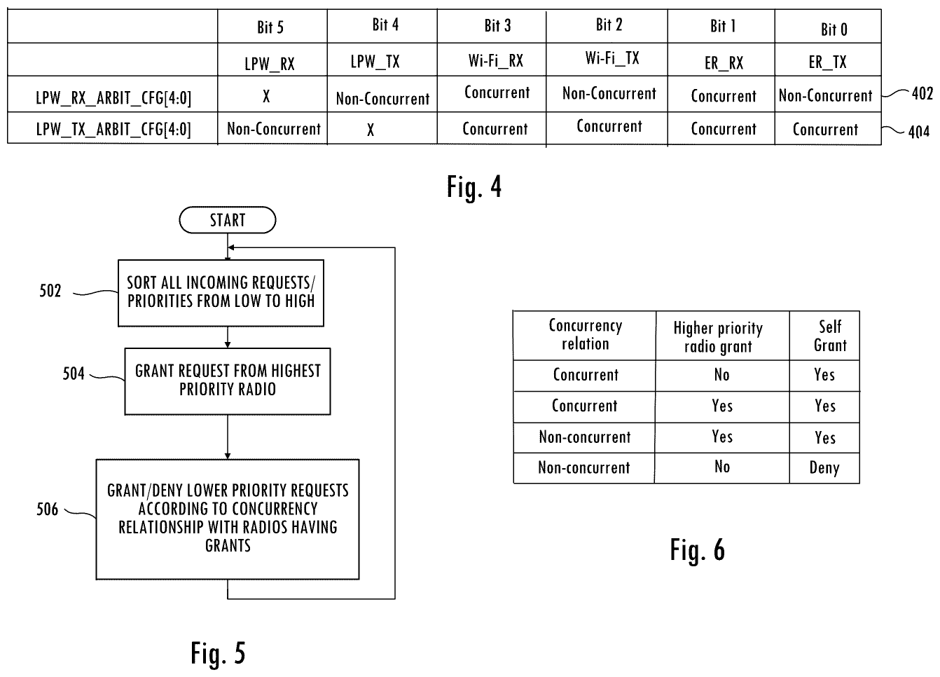

The software scheduler utilizes an individual configuration register for RX and TX for each radio. FIG. 4 illustrates an example of arbitration configuration registers 402 and 404 for the LPW radio 104 assuming there are three radios total in the system as shown in FIG. 1. The LPW radio has a receive arbitration configuration register (e.g., LPW_RX_ARBIT_CFG[5:0]) and a transmit arbitration configuration register (e.g., LPW_TX_ARBIT_CFG[5:0]). The arbitration configuration registers indicate the concurrency/non-concurrency for each radio. The illustrated arbitration configuration registers have six bits, two bits for each radio in the system. If there are more radios in the system, the configuration register will have the appropriate number of bits to support the number of radios in the system. As shown in FIG. 4, each radio's TX and RX has its own concurrencies. The concurrency information in the arbitration configuration registers is supplied to the PITA hardware block by the radios to form the arbitration matrix.

In the example configuration registers of FIG. 4, LPW_RX is non-current with LPW_TX, Wi-Fi_TX, and ER_TX. LPW_RX is allowed to be concurrent with Wi-Fi_RX and ER_RX. LPW_TX is non-current with LPW_RX, but is allowed to be concurrent with Wi-Fi_RX, Wi-Fi_TX, and ER_RX and ER_TX. The registers are located in the radios or elsewhere in the system and accessible to the software scheduler. Note it is assumed in the example of FIG. 4 that transmit (TX) and receive functions (RX) of a radio are non-concurrent. Note also that if radio[X] is configured as non-concurrent with radio[Y] in the radio[X] arbitration configuration register, the expectation is that radio[Y] is configured as non-concurrent with radio[X] in the radio[Y] arbitration configuration register. If two events are marked to be non-concurrent with respect to each other, the request from the higher priority radio will be granted by the PITA hardware block 102. The approach described herein allows for flexibility to accommodate future radio configurations.

FIG. 5 illustrates a flow chart of the operation of the PITA hardware block 102. First in 502, the PITA hardware block sorts the priorities of all incoming radio requests from high to low. In the illustrated embodiment, a lower priority number means a higher priority. The PITA hardware block grants the radio request with the highest priority in 504. In 506, the PITA hardware block looks for each radio (other than the highest priority radio which has received a grant) at all radios higher in priority than the radio being analyzed, and decides its grant by the table of its concurrency relationship with the higher priority radios (HPRs) and whether the HPRs have a grant. FIG. 6 illustrates the table of concurrency used to decide whether to grant lower priority radios their request. If any higher priority radio has a grant and is non-current with the lower priority radio the PITA hardware block denies the request from the lower priority radio. If the lower priority radio is concurrent with all higher priority radio(s) with a grant, the request from the lower priority radio is granted. If none of the higher priority radios with which the lower priority radio is non-concurrent have a grant, the PITA hardware block grants the request to the lower priority radio. The grant/deny determinations are performed for all the lower priority radios with an active request.

The following example illustrates the PITA hardware block arbitration operations. Assume there are 3 active radio requests. The requests are LPW_RX (priority 3), Wi-Fi_TX (Priority 5), and ER_TX (Priority 4). The lowest priority number, here priority 3, has the highest priority. The arbitration matrix relationship is as follows. LPW_RX and Wi-Fi_TX are concurrent. LPW_RX is concurrent with ER_TX. Finally, Wi-Fi_TX and ER_TX are non-concurrent. Stepping through the grant/deny flow diagram of FIG. 5 in the first step (502) the sorting takes place resulting in the priorities being first=LPW_RX, second=ER_TX, third=Wi-Fi_TX. In the second step (504) of the flow diagram, LPW_RX has highest priority, so the PITA hardware block grants the LPW_RX request. Finally, in the third step (506), for each lower priority radio the PITA hardware block looks at all radios higher in priority to the current lower priority radio being analyzed and decides its grant according to the concurrency table shown in FIG. 6. For the third step (506) of FIG. 5, first the next higher priority radio is ER_TX is processed and its higher priority radio (HPR) is LPW_RX. Since ER_TX and LPW_RX are concurrent, the request from ER_TX is granted. Finally, the third request (from Wi-Fi_TX) is processed. Wi-Fi_TX has 2 HPR's (LPWRX and ER_TX). Wi-Fi_TX is concurrent with LPWRX, it would get a grant based solely on LPW_RX but Wi-Fi_TX is non-concurrent with ER_TX and ER_TX has a grant. Since Wi-Fi TX and ER_TX cannot co-exist, i.e., are non-concurrent, the request from Wi-Fi_Tx is denied based on the grant to ER_TX and non-concurrency with ER_TX. Since Wi-Fi_TX got a deny from at least one HPR, its request does not get granted. The overall result for the three requests is LPW_RX is granted, ER_TX is granted, and Wi-Fi_TX is denied.

Embodiments of the PITA hardware block provide a grant mask function to mask grants to radios until all non-concurrent radios are off. Referring back to FIG. 1, each radio supplies a radio off signal 132. Note that the radios also send separate TX Active and RX Active signals as well. However, if TX Active and RX Active signals indicate the radio is no longer actively transmitting or receiving, parts of the radio, e.g., the modem, may still have some activity. In embodiments a grant mask enable bit for each radio enables that functionality. In other embodiments that functionality is always on. Assuming the grant mask functionality is on, if LPW_RX is programmed to be non-concurrent to Wi-Fi_TX and non-concurrent to ER_RX, the Grant and Deny signals responsive to the LPW_RX request are held to 0 (deasserted) until both the Wi-Fi radio and the external radio (ER) are off as indicated by their respective Radio Off signals.

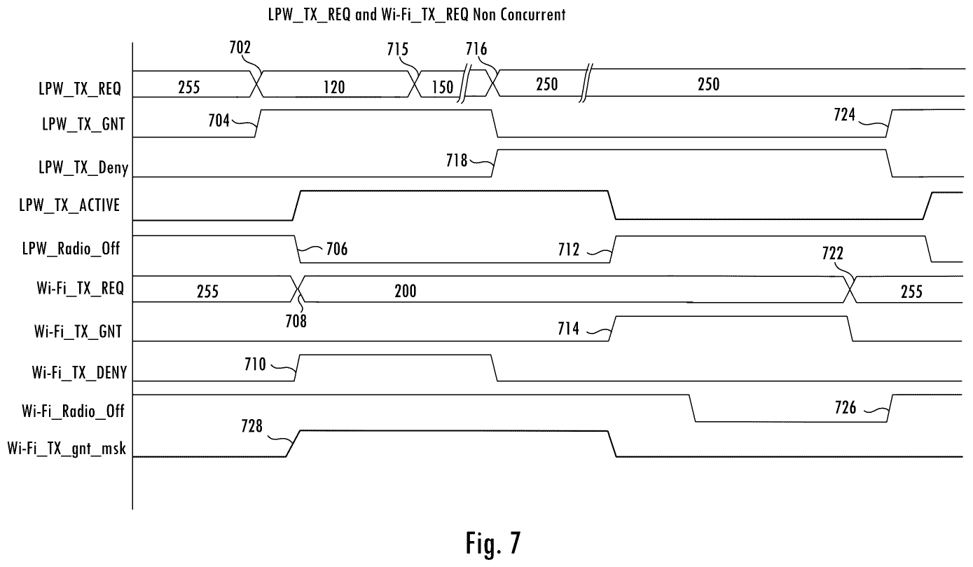

FIG. 7 is a timing diagram illustrating masking the grant until all non-concurrent radios are off. Non-concurrent radios mean any radio that has a TX request or a RX request that is non-concurrent. FIG. 7 shows only two requests (LPW_TX_REQ and WI-FI TX_REQ) for case of illustration. Those two radios (LPW_TX and WI-FI_TX) are non-concurrent in this example. LPW_TX_REQ changes from 255 (inactive) to 120 at 702 while the WI-FI_TX REQ bus remains at 255. That results in the grant (LPW_TX GNT) at 704. The LPW Radio Off signal is deasserted at 706 to reflect LPW transmissions. At 708 Wi-Fi_TX REQ becomes active with a priority of 200. However, that priority is lower than the priority 120 of LPW_TX_REQ resulting in the WI-FI_TX Deny being asserted at 710. At 715 the priority of the LPW_TX REQ is reduced to 150. Thus, as can be seen, the priority can be dynamic even in the middle of a transmission. At 716 the priority of LPW_TX_REQ is reduced to 250, which is a lower priority than the priority of Wi-Fi_TX_REQ, which is 200. The LPW_TX_Deny is asserted at 718. However, because an asserted LPW Radio Off has not yet been received, the grant to Wi-Fi_TX REQ is masked until LPW Radio Off is asserted at 712 resulting in Wi-Fi_TX GNT at 714. The priority of Wi-Fi_TX_REQ goes inactive (255) at 722 resulting in the grant LPW_TX GNT at 724 having been masked until Wi-Fi Radio Off is asserted at 726.

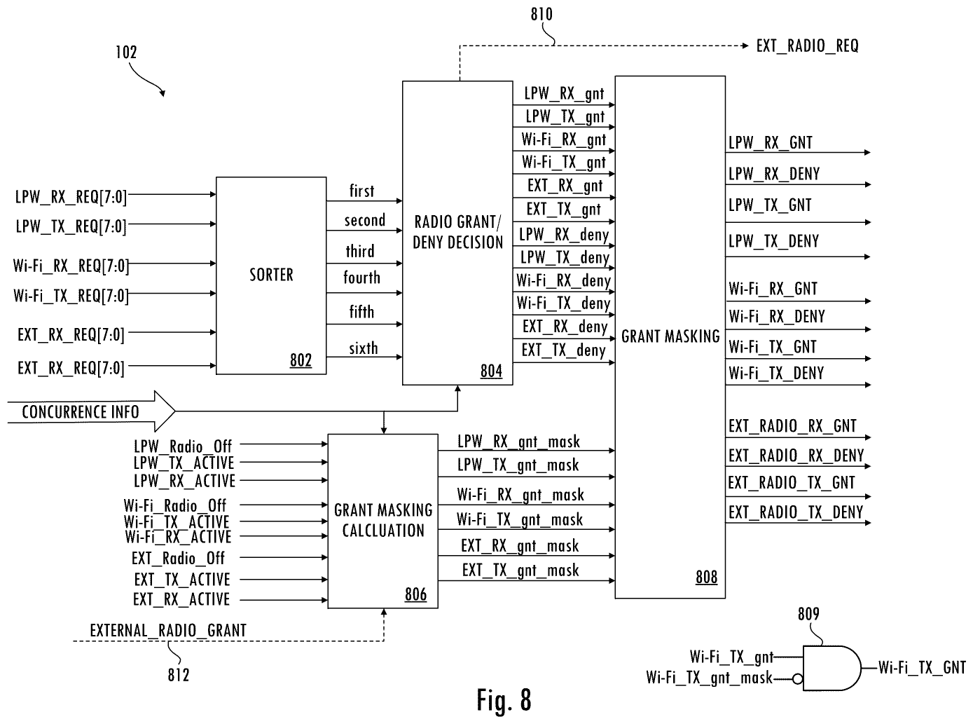

FIG. 8 illustrates a high level block diagram of the PITA hardware block 102 providing fast arbitration decisions compared to a software scheduler. In the embodiment illustrated in FIG. 8, the sorter block 802 is a circuit that receives 6 request buses, two from each radio. The six buses are the LPW_TX_REQ[0:7], the LPW_RX_REQ[0:7], Wi-Fi_TX_REQ[0:7], the Wi-Fi_RX_REQ[0:7], the EXT_RADIO_TX_REQ[0:7], and the EXT_RADIO_RX_REQ[0:7]. The sorter block 802 sorts the six requests from highest priority (first) to lowest priority (sixth) and supplies the sorted requests to the Radio Grant/Deny Decision Block 804. The Radio Grant/Deny Decision Block 804 is a circuit that performs steps 504 and 506 in the flow chart of FIG. 5. That is, the radio grant/deny decision block 804 grants the request to the highest priority request (sorted as first) and then issues grants or denials to lower priority radios according to their concurrence relationships with higher priority radios with grants. The concurrence relationships from arbitration configuration registers shown in FIG. 4 are supplied to the radio grant/deny decision block 804 and the grant masking calculation block 806. The radio grant/deny decision block 804 issues a deny if a lower priority radio is non-concurrent with a higher priority radio having a grant that has been generated by the radio grant/deny decision block 804. Thus, the radio grant/deny decision block issues six grant signals (two for each radio) and six deny signals (two for each radio) to the grant masking block 808. Note that the signals shown in lower case (gnt and deny) from the radio grant/deny decision block 804 are subject to masking by the grant masking block 808.

Grant masking calculation block 806 is a circuit that receives the radio status signals LPW_Radio_Off, Wi-Fi_Radio_Off, and EXT_Radio_Off and generates a mask signal for each request and supplies six mask signals (LPW_TX_GNT_MASK, LPW_RX_GNT_MASK, Wi-Fi_TX_GNT_MASK, Wi-Fi_RX_GNT_MASK, EXT_RADIO_TX_GNT_MASK, AND EXT_RADIO_RX_GNT_MASK. In addition to the radio off signals, the grant masking calculation block 806 receives active signals from each radio indicating what activity, if any, a radio is engaged in. Thus, the grant masking calculation block 806 receives the signals LPW_RX_ACTIVE and LPW_TX_ACTIVE which are asserted to indicate, respectively, receive and transmit activity by the LPW radio. The grant masking calculation block 806 also receives the signals Wi-Fi_RX_ACTIVE and Wi-Fi_TX_ACTIVE, which are asserted to indicate, respectively, receive and transmit activity by the Wi-Fi radio. The grant masking calculation block 806 also receives the signals EXT_RX_ACTIVE and EXT_TX_ACTIVE, which are asserted to indicate, respectively, receive and transmit activity by the external radio. The active signals are used by the grant masking logic to determine what a non-concurrent radio is currently doing to know whether to mask a grant. For example, if LPW_RX is concurrent to Wi-Fi_TX, but LPW_TX is non-concurrent to Wi-Fi_TX, if the Wi-Fi radio is transmitting (Wi-Fi_TX asserted and Wi-Fi_RX deasserted), there is no need to grant mask LPW_RX even through a non-concurrent radio is active. As mentioned above, even if the active signals are deasserted, the grant masking calculation block still uses the radio off signal to ensure a non-concurrent radio is inactive for masking purposes. For example, assume LPW_TX is non-concurrent to Wi-Fi_TX and the Wi-Fi radio is transmitting (Wi-Fi_TX asserted and Wi-Fi_RX deasserted), then a grant mask is issued for LPW_TX. That grant mask is not deasserted until Wi_Fi radio is off. Note that Wi-Fi_Radio_Off will be deasserted when the radio is transmitting or receiving (RX_ACTIVE or TX_ACTIVE).

When a radio is Grant masked its grant=0 and deny=0 as well. The six mask signals are supplied to the grant masking block 808, which is a circuit that includes the combinational logic to do the actual grant masking by combining the mask signals with appropriate grant and deny signals. Note that grant masking block 806 also receives signal 812 (EXTERNAL_RADIO_GRANT) whose function is described further herein. AND gate 809 illustrates an embodiment of the combinational logic to grant mask Wi-Fi TX_GNT. Referring back to FIG. 7, LPW_TX_ACTIVE signal asserts around 706 when LPW_Radio_Off is deasserted. Since LPW_TX_REQ and Wi-Fi_TX_REQ are non-concurrent, LPW transmissions being active results in Wi-Fi_TX_gnt_msk being asserted at 728 and being deasserted responsive to LPW_Radio_Off being asserted at 712. Note that even though Wi-Fi_TX_gnt_msk is asserted by the grant masking calculation block 806, that has no affect on the grant signal from grant masking block until 716 when the priority the priority of LPW_TX_REQ decreases to 250 (below Wi-Fi_TX_REQ at 200) and the grant signal is blocked until 714.

In at least one embodiment, the external radio has priority over the internal radios. In such an embodiment, if any of the granted internal radios is non-concurrent with the external radio then that triggers a request by the radio grant/deny decision block 804 to the external radio on the EX_RADIO_REQ signal 810. The external radio grants the internal radios permission on EXTERNAL_RADIO_GNT signal line 812 supplied to the grant masking calculation block 806. Thus, in an embodiment, the interface 125 (FIG. 1) with the external radio includes the external radio request and grant signals 810 and 812. Depending on the capabilities of the external radio, the grant and deny signals generated by the grant masking block 808 may not be supplied to the external radio. In other embodiments, the external radio sends and receives the same signals to the PITA hardware block 102 as the internal radios. In an embodiment interface 125 (FIG. 1) is a serial interface and the identical information that would be communicated over the individual signal lines EXT_Radio_Off, EXT_TX_ACTIVE, EXT_RX_ACTIVE, EXT_RADIO_RX_GNT, EXT_RADIO_TX_GNT, EXT_RADIO_RX_DENY, and EXT_RADIO_TX_DENY is communicated instead over the serial interface. Thus, the interface between the PITA hardware block 102 and the external radio is logically the same but physically different.

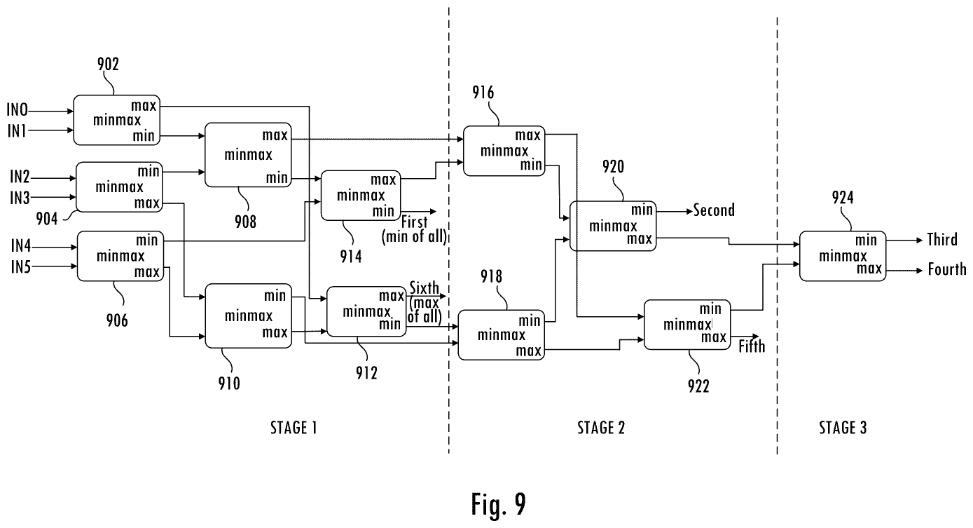

FIG. 9 illustrates an embodiment of the sorter. The sorter includes minmax blocks. A minmax block takes in two inputs and outputs a lower value of the two on the MIN output port and the higher value on MAX output port. The minmax port also takes in a tiebreaker bit to break the tie if both inputs are equal. The embodiment illustrated in FIG. 9 has three stages. In STAGE 1 three minmax blocks 902, 904, and 906 each take pairs of the six inputs shown as IN0 through IN5, which are the six request buses from the three radios. Stage 1 takes the ‘MAX’ output of the three minmax blocks 902, 904, and 906 and supplies them to the two minmax blocks 910 and 912 to find the maximum of all numbers. The MAX output of minmax block 912 is the “Sixth”, which is the maximum of all the inputs. Stage 1 also takes the ‘MIN’ output of the three minmax blocks 902, 904, and 906 and connects them to the two minmax blocks 908 and 914 to find the minimum of all the inputs. The MIN output of the minmax block 914 is the lowest of all the inputs (and thus labeled ‘First’) and is the highest priority assuming the lower number on the bus has a higher priority. The remaining 4 output ports of the minmax blocks in stage 1 are the inputs to the second stage.

In Stage 2 minmax blocks 916 takes the MAX outputs from blocks 908 and 914. Minmax block 918 takes the MIN outputs of minmax blocks 910 and 912. Minmax block 920 receives the MIN outputs of block 916 and 918 and supplies the second lowest element of the sorted inputs (labeled “Second”). Minmax block 922 receives the MAX outputs of minmax blocks 916 and 918. The MAX output of block 922 (labeled “Fifth”) is the second largest sorted element.

Finally, in stage 3, minmax block 924 receives the MAX output of minmax block 920 and the MIN of minmax block 922 and generates the third element (third lowest) of the inputs from the MIN output and the third highest element (“fourth” element) of the inputs from the MAX output. The sorted inputs, which are requests from the various radios, are supplied on the first through sixth inputs to radio grant/deny decision block 804.

Thus, techniques for performing real time arbitration for radio requests has been described. The description of the invention set forth herein is illustrative and is not intended to limit the scope of the invention as set forth in the following claims. The terms “first,” “second,” “third,” and so forth, as used in the claims, unless otherwise clear by context, are to distinguish between different items in the claims and do not otherwise indicate or imply any order in time, location or quality. Variations and modifications of the embodiments disclosed herein may be made based on the description set forth herein, without departing from the scope of the invention as set forth in the following claims.

What is claimed is:

1. A method for arbitrating radio requests from a plurality of radios comprising:
receiving a plurality of radio requests from the plurality of radios at an arbitration circuit;
sorting the radio requests to rank the radio requests according to priority;
granting a highest priority radio request of the plurality of radio requests; and
either granting or denying each remaining lower priority radio request of the plurality of radio requests according to respective concurrency relationships between each remaining lower priority radio request with every higher priority radio request that has a grant.

2. The method as recited in claim 1 further comprising each of the plurality of radios generating separate transmit requests and receive requests.

3. The method as recited in claim 1 further comprising granting a second radio request from a second radio, the second radio request being concurrent with every higher priority radio request that has a current grant.

4. The method as recited in claim 3 further comprising delaying another grant to another radio request until all other non-concurrent radios are off.

5. The method as recited in claim 3 further comprising denying a third request from a third radio, the third request being non-concurrent with at least one higher priority radio request that has a grant.

6. The method as recited in claim 5 further comprising programming priorities of each of the plurality of radio requests.

7. The method as recited in claim 5 further comprising using a tie breaker bit to determine which of the plurality of radio requests has a higher priority if two of the radio requests have equal priority.

8. The method as recited in claim 5 further comprising supplying the radio requests over respective buses from the radios to the arbitration circuit.

9. The method as recited in claim 8 wherein a particular value on the respective buses indicates no request.

10. An apparatus comprising:
a plurality of radios;
arbitration circuit coupled to receive a plurality of radio requests from the plurality of radios;
wherein the arbitration circuit includes,
a sorting circuit to rank the radio requests according to priority;
a grant/deny circuit to generate a first grant signal to a highest priority radio request of the plurality of radio requests requested by a first radio; and
wherein the grant/deny circuit is further configured to generate a grant or deny to each remaining lower priority radio request of the plurality of radio requests according to a concurrency relationship between each of the remaining lower priority radio requests and each higher priority radio request that has a grant generated by the grant/deny circuit.

11. The apparatus as recited in claim 10 wherein each of the radios generates a transmit request and a receive request.

12. The apparatus as recited in claim 10 wherein the grant/deny circuit is configured to grant a second radio request from a second radio, the second radio request being concurrent with each higher priority radio request that has a grant.

13. The apparatus as recited in claim 12 wherein the grant/deny circuit is configured to deny a third radio request from the first radio responsive to the third radio request being non-concurrent with at least one higher priority radio request that has a grant.

14. The apparatus as recited in claim 13 further comprising:
a first grant signal line coupled between the arbitration circuit and the first radio, the first grant signal line being asserted by the arbitration circuit to indicate that the highest priority radio request from the first radio is being granted;
a second grant signal line coupled between the arbitration circuit and the second radio, the second grant signal line being asserted by the arbitration circuit to indicate that the second radio request is being granted; and
a deny signal line coupled between the arbitration circuit and the first radio, the deny signal line being asserted by the arbitration circuit to indicate that the third radio request from the first radio is being denied.

15. The apparatus as recited in claim 10 wherein the arbitration circuit further comprises a masking circuit to mask a grant to a radio request until all non-concurrent radios are off.

16. The apparatus as recited in claim 10 wherein the sorting circuit is configured to utilize a tie breaker bit to determine which of the plurality of radio requests has the highest priority if two of the radio requests have equal priority.

17. The apparatus as recited in claim 10 further comprising a plurality of request buses coupled between respective radios and the arbitration circuit over which requests are supplied by the radios to the arbitration circuit, respective values of the request buses indicating priorities of the requests.

18. The apparatus as recited in claim 17 wherein the plurality of radios includes at least two radios on an integrated circuit and another radio external to the integrated circuit.

19. The apparatus as recited in claim 18 further comprising respective radio off signal lines supplied from the at least two radios to the arbitration circuit.

20. An apparatus comprising:
a plurality of radios including a first radio and a second radio;
arbitration circuit coupled to receive a plurality of radio requests from the plurality of radios;
wherein the arbitration circuit includes,
sorting circuit to rank the radio requests according to priority;
a grant circuit to generate a grant signal to a highest priority radio request of the plurality of radio requests;
wherein the grant circuit is further configured to generate a grant or deny to each remaining lower priority radio request of the plurality of radio requests according to a concurrency relationship between each of the remaining lower priority radio requests and each higher priority radio request that has a grant generated by the grant circuit;
a first transmit request bus coupled between the first radio and the arbitration circuit;
a first receive request bus coupled between the first radio and the arbitration circuit;
a second transmit request bus coupled between the second radio and the arbitration circuit;
a second receive request bus coupled between the second radio and the arbitration circuit;
a first transmit grant signal line coupled between the arbitration circuit and the first radio, wherein the first transmit grant signal line is asserted to indicate a first transmit request on the first transmit request bus is being granted;
a first receive grant signal line coupled between the arbitration circuit and the first radio, wherein the first receive grant signal line is asserted to indicate a first receive request on the first receive request bus is being granted;
a second transmit grant signal line coupled between the arbitration circuit and the second radio, wherein the second transmit grant signal line is asserted to indicate a second transmit request on the second transmit request bus is being granted;
a second receive grant signal line coupled between the arbitration circuit and the second radio, wherein the second receive grant signal line is asserted to indicate a second receive request on the second receive request bus is being granted;
a first transmit deny signal line coupled between the arbitration circuit and the first radio, wherein the first transmit deny signal line is asserted to deny a third transmit request on the first transmit request bus;
a first receive deny signal line coupled between the arbitration circuit and the first radio, wherein the first receive deny signal line is asserted to deny a third receive request on the first receive request bus;
a second transmit deny signal line coupled between the arbitration circuit and the second radio, wherein the second transmit deny signal line is asserted to deny a fourth transmit request on the second transmit request bus; and
a second receive deny signal line coupled between the arbitration circuit and the second radio, wherein the second receive deny signal line is asserted to deny a fourth receive request on the second receive request bus.
